(19) United States
(12) Patent Application Publication
(10) Pub. No.: US 2015/0075537 A1
(43) Pub. Date: Mar. 19, 2015

(54) Method and apparatus for securing a patient's hand during arthroscopy and surgery

(71) Applicant: Edward DeMayo, San Raphael, CA (US)

(72) Inventor: Edward DeMayo, San Raphael, CA (US)

(21) Appl. No.: 13/987,890

(22) Filed: Sep. 13, 2013

(51) Int. Cl. A61G 13/12

(52) U.S. Cl. CPC A61G 13/124; A61G 13/1235; A61G 13/129; A61G 13/1295; A61G 13/126
USPC 128/845

(57) ABSTRACT

An extended flexible meshed enclosure is arranged between a patient's hand and a support plate upstanding from the associated operating table to support the patient's hand during surgery of the patient's associated limb. To assist in holding the meshed enclosure to the support plate a first part of said meshed enclosure is captured within a top extending slot on said support plate and a second part of said meshed enclosure is captured within a bottom extending slot on said support plate.

### BACKGROUND OF THE INVENTION

A Patient's hand is currently restrained for associated limb arthroscopy and surgery by capturing the patient's fingers within one end of a flexible meshed enclosure and securing the opposite end of the meshed enclosure to a support upstanding from the operating room (OR) table.

U.S. Pat. No. 4,445,506 entitled “Bone Aligning Apparatus” describes an early arrangement wherein the patient's hand is restrained in a vertical position on the OR table.

U.S. Pat. No. 6,467,487 entitled “Holding Device for Wrist/Shoulder Arthroscopy and Surgery” describes a more recent arrangement wherein the patient's hand is restrained in a supine position on the OR table.

One arrangement for attaching the opposite end of the meshed enclosure to a support upstanding from the OR table is described in US Patent Application Publication US2011/0178449 entitled “Traction Device”.

A further arrangement is found within U.S. patent application Ser. No. 13/694,652 entitled “Method and Apparatus for Securing a Patient's Hand During Arthroscopy and Surgery”, which application is incorporated herein for purposes of reference. The meshed enclosure containing the patient's hand is connected with the OR table by a pole and clamp arrangement as described therein.

One purpose of the instant invention is to describe a simpler and less expensive arrangement for connecting the meshed enclosure containing the patient's hand to the OR table support, per se.

### SUMMARY OF THE INVENTION

An extended flexible meshed enclosure is arranged between a patient's hand and a V-grooved support plate upstanding from the associated operating table for capturing the patient's fingers within one end of the meshed enclosure and for capturing the opposite end of the flexible meshed enclosure within the V-grooved support plate. To secure the meshed enclosure to the support plate a first part of the end of the enclosure opposite the hand is captured within a V-shaped groove on the top of the support plate and a second part of the end of the enclosure opposite the hand is captured within a V-shaped grove on the bottom of the support plate.

### BRIEF DESCRIPTION OF THE DRAWINGS

FIG. 1A is a front perspective view of the flexible meshed enclosure according to the invention prior to engaging a finger of an associated patient's hand;

FIG. 1B is a front perspective view of the flexible meshed enclosure of FIG. 1A engaging a finger of the associated patient's hand prior to wrapping a hook and loop strap about the enclosed finger;

FIG. 1C is a front perspective view of the flexible meshed enclosure of FIG. 1B with the hook and loop strap wrapped about the enclosed finger; and

FIG. 2 is an end view of a patient on an OR table with the flexible meshed enclosure about the patient's hand as shown in FIG. 1C attached to the support plate upstanding from an operating table in accordance with the invention.

### DESCRIPTION OF THE PREFERRED EMBODIMENT

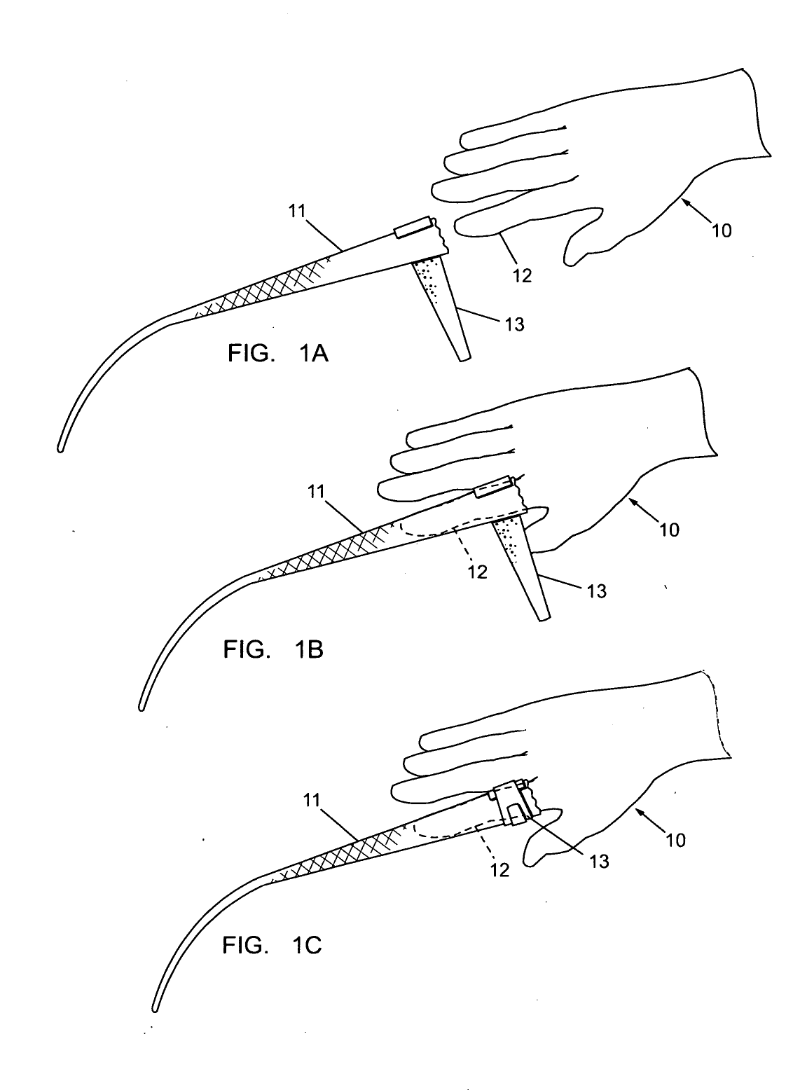

As now shown in FIG. 1A a flexible meshed enclosure 11 of polystyrene plastic is arranged next to the finger 12 of a patient's hand 10 and is moved over the finger as shown in FIG. 1 B. According to the teachings of the invention, a hook and loop strap 13 is positioned under the finger 12 enclosed within one end of the meshed enclosure 11 for encompassing the enclosed finger 12 as shown in FIG. 1C. The hook and loop strap 13 can consist of a plastic tape with Velcro fasteners as supplied by International Velcro Industries of Nyon Switzerland. “Velcro” is a registered trademark belonging to Velcro Industries of Curacao, Netherlands.

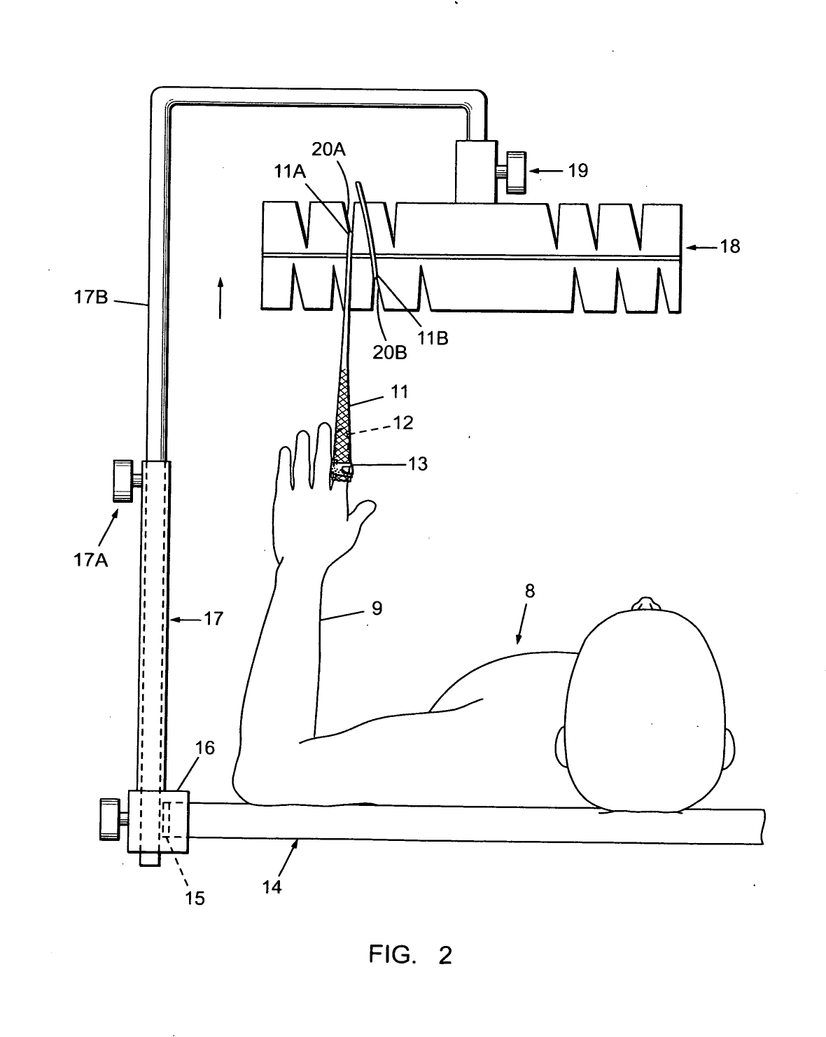

Although one finger 12 is shown with the flexible meshed enclosure 11 encompassed thereon, for purposes of clarity, all the fingers could have flexible meshed enclosures 11 to assure adequate support to the associated limb, such as the arm 9 of the patient 8, as depicted in FIG. 2.

An operating table, hereafter “OR” table 14, is shown in FIG. 2 with a support post 17 attached to the operating table side rail 15 via the OR side rail clamp 16 such as that described within U.S. Pat. No. 7,003,827 entitled “Operating Table Support Clamp”, which patent is incorporated herein for purposes of reference. The patient's hand support plate 18 is adjustably attached to the support post 17 via a threaded knob 17A which allows movement of the inner support post 17B, attached to the support plate via threaded knob 19, to move the support plate in the vertical direction, as indicated.

The support plate 18 includes a plurality of top extending V-shaped grooves 20A for receiving within one of the grooves a first distal part 11A of the flexible meshed enclosure 11 opposite the patient's finger 12 which is enclosed within the hook and loop strap 13, as shown earlier in FIG. 1C. To further secure the meshed enclosure 11 to the support plate 18, a second distal part 11B of the flexible meshed enclosure 11 is received within one of a plurality of bottom extending V-shaped grooves, as indicated at 20B.

As also described earlier, only one finger 12 on the hand 10 is shown enclosed within a flexible meshed enclosure 11, yet all the fingers could be enclosed within separate flexible meshed enclosures 11 and hook and looped straps 13 to insure fixation of the hand 10 during surgery on the associated arm 9, if required.

Upon movement of the support plate 18 in the upwards vertical direction, as indicated in FIG. 2, the hook and loop strap 13 prevents the meshed enclosure 11 from separating from the finger 12 whereas the positioning of the distal ends 11A, 11B of the meshed enclosure 11 within the top and bottom extending V-shaped grooves 20A, 20B further prevent removal of the meshed enclosure 11 from the support plate 18 during associated surgery on the patient 8.

Once the surgery on the associated limb is completed, the finger 12 is detached from the flexible meshed enclosure 11 by removing the hook and loop strap 13 from the flexible meshed enclosure while the meshed enclosure 11 is removed from the support plate 18 by removing the distal ends 11A, 11B of the meshed enclosure 11 from the top and bottom extending V-shaped grooves 20A, 20B.

It is noted that the use of a single support plate having top and bottom extending V-shaped grooves to retain the meshed enclosure without requiring an additional plate and bolts, as required by the Prior Art of record is a substantial benefit in view of the simplification of the sterilization procedure and the advantage of material cost savings.

Apparatus has been shown herein for retaining the fingers of a patient's hand for applying support to an associated patient's limb without limiting the pressure applied to the limb to deter removable of the patient's hand during limb surgery.

What is claimed is:

1. An arrangement for securing a patient's fingers during surgery on an associated limb comprising:
at least one elongated meshed enclosure arranged for receiving a patient's finger at one end and for attaching an opposite end of said meshed enclosure to a support plate on an operating table, wherein said support plate defines at least one top extending V-shaped groove arranged for receiving one part of said opposite end of said meshed enclosure and said support plate defines at least one bottom extending V-shaped groove arranged for receiving a further part of said opposite end of said meshed enclosure.

2. The arrangement of claim 1 wherein said support plate includes means at one end thereof for attaching to a top of a post extending upright from said operating table.

3. The arrangement of claim 2 wherein said means at said one end of said support plate comprises an aperture arranged for receiving said top of said post extending upright from said operating table.

4. The arrangement of claim 1 including means at a bottom of said post for securing said post to said operating table.

5. The arrangement of claim 7 wherein said means at said bottom of said post comprises an operating table clamp.

6. A method for retaining a patient's limb during surgery comprising the steps of: capturing at least one of a patient's fingers in a meshed enclosure at one end of said meshed enclosure;
arranging a strap around said finger within said meshed enclosure; and
attaching an opposite end of said meshed enclosure to a support plate upstanding from said operating table.

7. The method of claim 6 wherein said step of attaching said opposite end of said meshed enclosure to said support plate includes capturing a part said opposite end of said meshed enclosure within a top extending V-shaped groove arranged on said support plate.

8. The method of claim 7 including the step of attaching said opposite end of said meshed enclosure to said support plate includes capturing a further part of said opposite end of said meshed enclosure within a bottom extending V-shaped groove arranged on said support plate.
